(19) United States
(12) Patent Application Publication
(10) Pub. No.: US 2026/0074352 A1
(43) Pub. Date: Mar. 12, 2026

(54) BATTERY MODULE

(71) Applicant: TOYOTA JIDOSHA KABUSHIKI KAISHA, Toyota-shi (JP)

(72) Inventors: Tomoya HAYASHI, Nagoya-shi (JP); Yusuke TAKASHI, Toyota-shi (JP)

(73) Assignee: TOYOTA JIDOSHA KABUSHIKI KAISHA, Toyota-shi (JP)

(21) Appl. No.: 19/276,240

(22) Filed: Jul. 22, 2025

(30) Foreign Application Priority Data
Sep. 6, 2024 (JP) 2024-154115

(51) Int. Cl. H01M 50/291; H01M 50/258

(52) U.S. Cl. CPC H01M 50/291; H01M 50/258

(57) ABSTRACT

A battery module includes: battery cells stacked in a first direction; and a spacer disposed between the plurality of battery cells adjacent to each other. Each of the battery cells includes a rectangular battery case containing an electrode body and an electrolyte solution therein, the spacer includes a pressing portion configured to press the battery cells in the first direction by making contact with a predetermined pressing region of the rectangular battery case, the pressing region is configured to overlap a central portion of the electrode body and not to overlap both end portions of the electrode body in a width direction of the battery cell, and the pressing portion has a shape in which a portion overlapping a lower side portion than the central portion of the electrode body is larger than a portion overlapping an upper side portion than the central portion of the electrode body.

The present application claims priority to and incorporates by reference the entire contents of Japanese Patent Application No. 2024-154115 filed in Japan on Sep. 6, 2024.

### BACKGROUND

The present disclosure relates to a battery module.

JP 2021-131967, in a battery module in which a plurality of battery cells are stacked, a spacer is disposed between the battery cells adjacent to each other, the battery cells by abutting the convex ribs provided on the spacer on the outer surface of the battery case it is disclosed that imparting a restraining load to. The long side surface of the outer surface of the battery case that abuts the rib includes a restraining region in which the rib abuts and a non-restraining region in which the rib does not abut.

### SUMMARY

In the secondary battery, since the expansion and contraction of the electrode body and the volume expansion of the electrolytic solution due to charging and discharging occur, the electrolytic solution is sometimes pushed out from the inside of the electrode body by the pump action caused by expansion and contraction of the electrode body and volume expansion of the electrolytic solution. In this case, there is a possibility that the resistance of the battery cell increases due to uneven concentration of the electrolytic solution in the inside of the electrode body.

In the configuration described in JP 2021-131967, in the interior of the battery case containing the electrode body and the electrolyte solution, to regulate the movement of the electrolyte solution in a portion corresponding to the restraining region of the electrode body, the electrode body to remain the electrolyte solution in a portion corresponding to the non-restraining region. Thus, it is suppressed that the electrolytic solution inside the electrode body flows out, and it is suppressed that the concentration unevenness of the electrolytic solution occurs inside the electrode body. However, in the configuration described in JP 2021-131967, it is not possible to cope with the elimination of the concentration unevenness with respect to the concentration unevenness of the electrolytic solution which has once been made in the inside of the electrode body, and there is room for improvement.

There is a need for a battery module capable of eliminating unevenness in concentration of an electrolytic solution when unevenness in concentration of an electrolytic solution occurs inside an electrode body.

According to one aspect of the present disclosure, there is provided a battery module including: a plurality of battery cells stacked in a first direction; and a spacer disposed between the plurality of battery cells adjacent to each other, wherein each of the plurality of battery cells includes a rectangular battery case containing an electrode body and an electrolyte solution therein, the spacer includes a pressing portion configured to press the plurality of battery cells in the first direction by making contact with a predetermined pressing region of an outer surface of the rectangular battery case, the pressing region, as viewed from the first direction, is configured to overlap a central portion of the electrode body and not to overlap both end portions of the electrode body in a width direction of the battery cell, and the pressing portion, when viewed from the first direction, has a shape in which a portion overlapping a lower side portion than the central portion of the electrode body is larger than a portion overlapping an upper side portion than the central portion of the electrode body.

### BRIEF DESCRIPTION OF THE DRAWINGS

FIG. 1 schematically illustrates a battery module according to an embodiment;

FIG. 2 is a diagram for explaining a spacer;

FIG. 3 is a diagram for explaining the pressing region;

FIG. 4 is a diagram for explaining the positional relationship between the pressing region and the electrode body;

FIG. 5 is a diagram for explaining an electrode body and an electrolytic solution;

FIG. 6 is a diagram for explaining the concentration unevenness of the electrolytic solution generated inside the electrode body;

FIG. 7 is a diagram for explaining the density of the electrolytic solution;

FIG. 8 is a diagram for explaining a state of the battery module being air-cooled;

FIG. 9 is a diagram for explaining a temperature difference between the central portion side and both end portions of the electrode body by partially cooling the electrode body; and

FIG. 10 is a diagram for explaining that the resistance of the battery cell is reduced by the concentration unevenness of the electrolyte is relaxed.

### DETAILED DESCRIPTION

Hereinafter, a battery module according to an embodiment will be described. Note that the present disclosure is not limited to the embodiment described below.

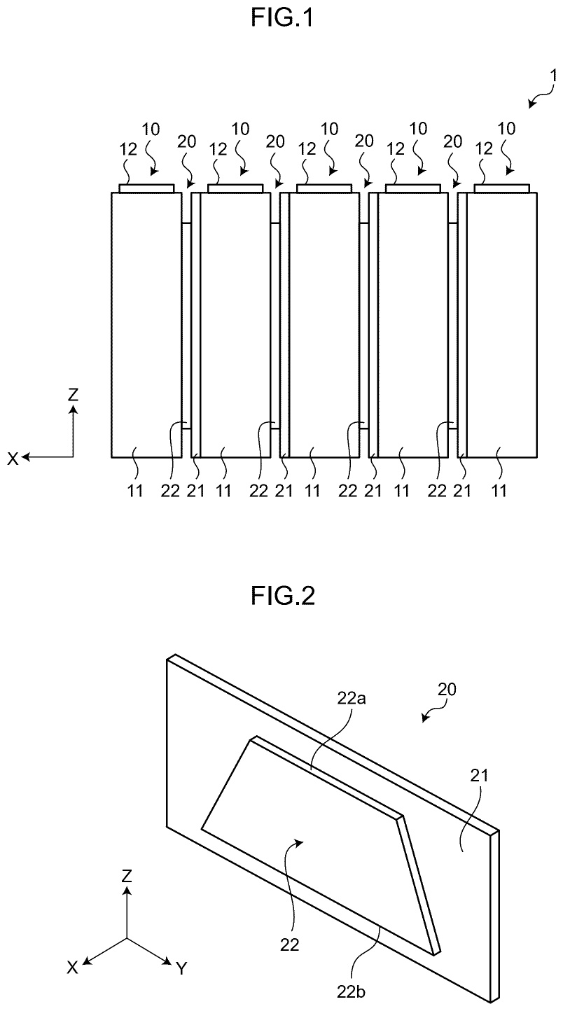

FIG. 1 is a diagram schematically illustrating a battery module in the embodiment.

The battery module 1 is a assembled battery in which a plurality of battery cells 10 are stacked. The battery module 1 includes a plurality of battery cells 10, a spacer 20 disposed between the battery cells 10 adjacent to each other. The battery cell 10 is a square cell. The battery cell 10 has a square battery case 11, and a terminal 12.

The battery module 1 includes a laminate in which the battery cell 10 and the spacer 20 are alternately stacked in the first direction X. The restraining load is compressed in the first direction X by such restraining member acts on the laminate. For example, the restraining member includes a pair of end plates and a restraining band. By this restraining load, the spacer 20 presses the battery cell 10 in the first direction X. The first direction X is the same direction as the stacking direction of the battery module 1, the same direction as the thickness direction of the battery cell 10.

The spacer 20 has a flat plate portion 21, and a pressing portion 22 projecting from the flat plate portion 21 in the first direction X. Between adjacent battery cells 10, the flat plate portion 21 abuts against one of the battery cells 10, the pressing portion 22 abuts against the other battery cell 10. The flat plate portion 21 is formed in a shape corresponding to the battery case 11, in contact with the long side 13a of the battery case 11 in one of the battery cells 10, facing the long side 13a of the battery case 11 in the other battery cell 10.

As illustrated in FIG. 2, the flat plate portion 21 is formed in a rectangular shape having a second direction Y in the longitudinal direction and a third direction Z in the transverse direction. The pressing unit 22, the upper bottom 22a is formed in a shorter trapezoidal shape than the lower bottom 22b. The top 22a and the bottom 22b extend along the second direction Y. In the spacer 20 pressing portion 22 is formed at a central position of the flat plate portion 21. The second direction Y is in the same direction as the width direction of the battery cell 10. The third direction Z is the same direction as the height direction of the battery cell 10, the same direction as the height direction of the trapezoidal shape in the pressing portion 22.

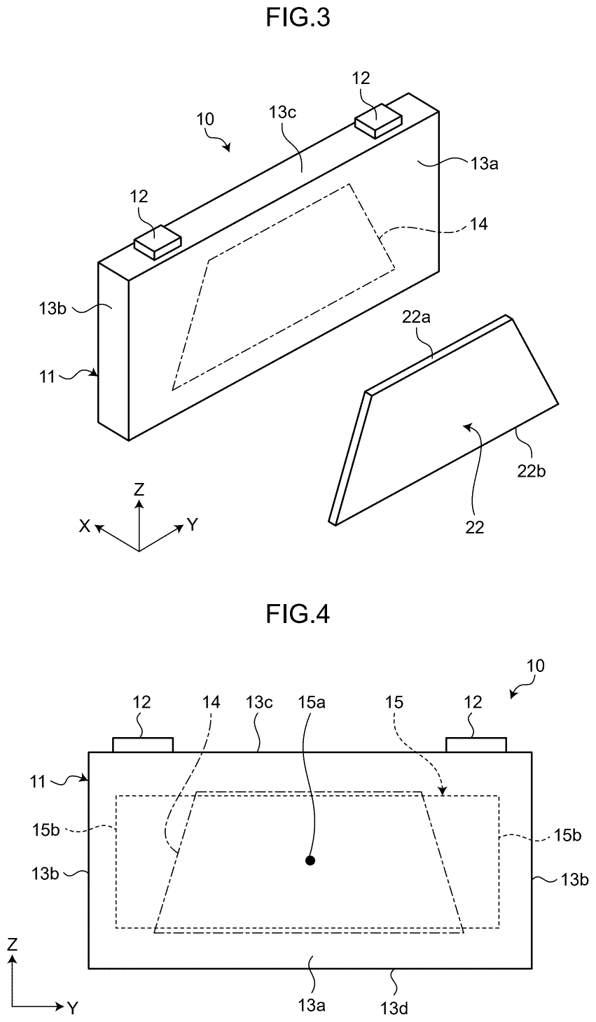

As illustrated in FIG. 3, the outer surface of the battery case 11 includes a pair of long side 13a formed on both sides of the first direction X, a pair of short side 13b formed on both sides of the second direction Y, the upper surface 13c, and the lower surface 13d. The long side 13a faces the flat plate portion 21 in the first direction X, a surface in contact with the pressing portion 22. The long side 13a, the pressing portion 22 includes a pressing region 14 abuts, the pressing portion 22 includes a region that does not contact. The pressing region 14 becomes the same trapezoid as the pressing portion 22. For convenience of explanation, the flat plate portion 21 is omitted in FIG. 3, only the pressing portion 22 of the spacer 20 is shown.

The pressing region 14 is a portion where the pressing portion 22 is in contact, a region to be pressed in the first direction X by the pressing portion 22. The pressing portion 22 presses the battery cell 10 in contact with the pressing area 14 of the long side 13a in the first direction X. The pressing portion 22 may press the electrode body 15 in the battery case 11 by pressing the pressing region 14.

As illustrated in FIG. 4, the pressing region 14, when viewed from the first direction X, a region overlapping the central portion 15a of the electrode body 15, and the both end portions 15b, 15b of the electrode body 15 in the width direction of the battery cell 10 a region that does not overlap. The central portion 15a is a central portion in the second direction Y, and a central portion in the third direction Z. The end 15b is the end of the second direction Y. As illustrated in FIG. 5, the inside of the battery case 11, the electrode body 15 and the electrolyte solution are accommodated.

The electrode body 15 is a wound electrode body upper and lower sides are sealed in the height direction of the battery cell 10. In the electrode body 15, one end 15b is a positive electrode connection portion in which only a portion in which the positive current collector is exposed is wound, and the other end 15b is a negative electrode connection portion in which only a portion in which the negative current collector is exposed is wound. The positive electrode connection portion is connected to the terminal 12 on the positive electrode side, and the negative electrode connection portion is connected to the terminal 12 on the negative electrode side. Both end 15b are open width direction of the cell 10, and the electrolyte may move between the inside and the outside of the electrode 15 through the end 15b. The electrolyte solution is present inside the electrode body 15 and exists as an excess liquid 16 outside the electrode body 15. Most of the electrolytic solution penetrates into the inside of the electrode body 15. The excess liquid 16 which does not penetrate into the electrode 15 is accumulated on the lower surface 13d side in the battery case 11.

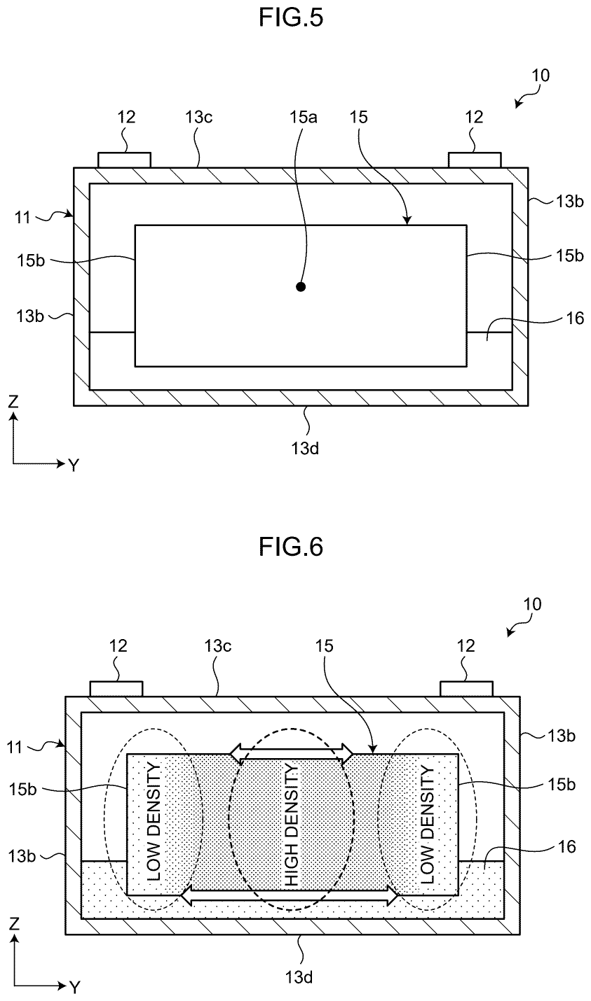

When the battery cell 10 repeats charging and discharging, the electrolytic solution is pushed out from the inside of the electrode body 15 by a pumping action caused by expansion and contraction of the electrode body 15 due to charging and discharging and volume expansion of the electrolytic solution. Since the end 15b on both sides are open in the electrode body 15, the electrolyte inside the electrode body 15 flows out from the end 15b. As a consequence, As illustrated in FIG. 6, the concentration of the electrolytic solution is concentrated on the central portion 15a side, and both end portions 15b side are thinned, so that concentration irregularity of the electrolytic solution occurs inside the electrode 15.

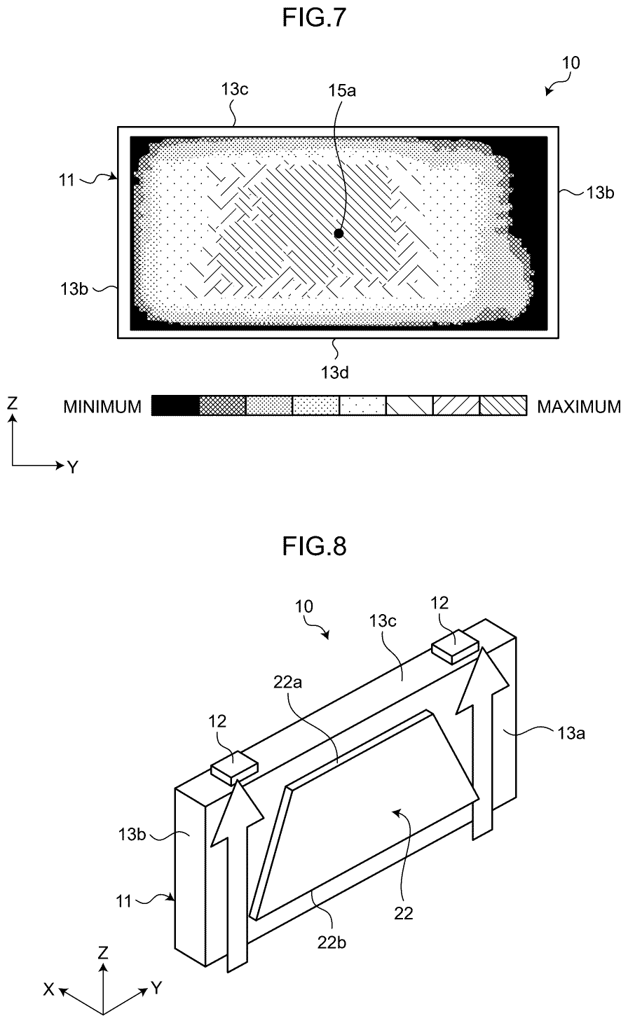

Since the lower side of the electrode body 15 is immersed in the excess liquid 16, a region having a higher concentration of the electrolytic solution is wider in the region of the lower side than in the region of the upper side inside the electrode body 15. When the concentration irregularity of the electrolyte occurs inside the electrode body 15, the internal resistance of the battery cell 10 increases. As illustrated in FIG. 7, the concentration of the electrolyte as viewed from the first direction X was analyzed by electrolyte solution analysis (XRF analysis) for the battery cell 10 when the resistivity increased temporarily. As a result, it was found that the central portion 15a was the densest, and the lower portion had a trapezoidal shape in which a higher-concentration area was widened.

In order to reduce the internal resistance of the battery cell 10 increased by the concentration unevenness of the electrolytic solution as described above, it is necessary to eliminate the concentration unevenness of the electrolytic solution inside the electrode body 15. In order to eliminate unevenness in the concentration of the electrolytic solution generated inside the electrode body 15, it is conceivable to flow the electrolytic solution inside the electrode body 15 so that the concentration of the electrolytic solution becomes uniform. Therefore, the present inventors have focused on that the electrolyte solution is diffused inside the electrode body 15 by the temperature difference inside the electrode body 15. The higher the temperature of the electrolyte, the more easily the electrolyte diffuses. In the battery module 1, only the partial 15c having a high concentration of the electrolytic solution among the electrode bodies 15 is pressed by the pressing portion 22, and a portion having a low concentration of the electrolytic solution among the electrode bodies 15 is actively cooled, so that a temperature difference is applied between the central portion 15a side and both end portions 15b side of the electrode bodies 15. Thus, a thick electrolytic solution existing in the central region of the electrode body 15 is moved, and relaxation of the concentration unevenness of the electrolytic solution may be promoted inside the electrode body 15.

Specifically, the pressing region 14, As illustrated in FIG. 4, when viewed from the first direction X, the region for pressing the lower portion than the central portion 15a of the electrode body 15 is set to be larger than the region for pressing the upper portion than the central portion 15a of the electrode body 15. That is, the pressing portion 22, as viewed from the first direction X, a portion overlapping the portion of the electrode body 15 lower than the central portion 15a is formed in a larger shape than the portion overlapping the upper portion than the central portion 15a of the electrode body 15.

For example, the pressing portion 22 is disposed so as to abut against the central portion of the long side 13a.

The upper bottom 22a of the pressing portion 22 is formed to be 60 to 65% of the length of the cell 10. The lower bottom 22b of the pressing portion 22 is formed in a length of 70 to 80% with respect to the width of the battery cell 10. The trapezoidal height of the pressing portion 22 is formed in a length of 70 to 80% with respect to the height of the battery cell 10.

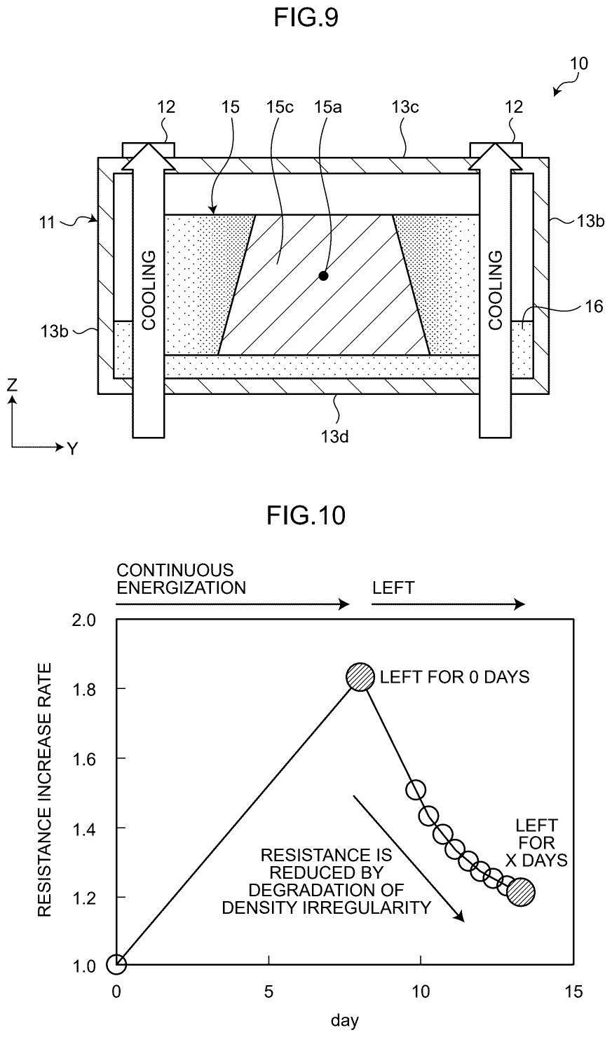

As illustrated in FIG. 8, since the battery module 1 is air-cooled, between the battery cells 10 adjacent to each other, the pressing portion 22 of the long side 13a it is possible to flow the cooling air to the area where not in contact. At that time, As illustrated in FIG. 9, the electrode body 15, although the portion which is not pressed by the pressing portion 22 is cooled by the cooling air, since the portion which is pressed by the pressing portion 22 is not actively cooled by the cooling air, the battery cell 10 temperature difference in the width direction. Consequently, the central part 15a has a high temperature and the end part 15b has a low temperature. Since the electrolytic solution diffuses from a part having a high temperature to a part having a low temperature, the electrolytic solution having a high concentration diffuses from a region 15a the central portion to a region 15b the end portion, and the concentration gradient of the electrolytic solution is relaxed inside the electrode body 15. Thus, it is possible to promote the relaxation of the concentration unevenness of the electrolytic solution by the temperature difference of the electrode body 15. As illustrated in FIG. 10, when the relaxation of the concentration irregularity of the electrolytic solution is promoted inside the electrode body 15, the internal resistance of the battery cell 10 decreases. Thus, the battery module 1 may eliminate the density unevenness that has been once in the interior of the electrode body 15, it is possible to exhibit the original battery performance.

As described above, according to the embodiment, the temperature difference of the electrode body 15 caused by the portion that is pressed by the pressing portion 22 and the portion that is not pressed against the pressing portion 22, the diffusion of the electrolyte solution inside the electrode body 15 is promoted, it is possible to eliminate the density unevenness once.

The pressing portion 22 is not limited to cases where both the upper bottom 22a and the lower bottom 22b and hypotenuse are straight. The pressing unit 22 may be, for example, the upper bottom 22a may be a shape curved in a curved shape, hypotenuse may be a shape curved in a curved shape. In short, the pressing portion 22 may be formed in a substantially trapezoidal shape.

According to the present disclosure, it is possible to eliminate the concentration unevenness of the electrolytic solution when the concentration unevenness of the electrolytic solution occurs inside the electrode body.

While the embodiment of the present application has been described in detail based on the drawings, it is illustrative, and it is possible to implement the present disclosure in other forms which are variously modified and improved based on the knowledge of those skilled in the art, starting from the aspects described in the column of the disclosure.

What is claimed is:

1. A battery module comprising:
a plurality of battery cells stacked in a first direction; and
a spacer disposed between the plurality of battery cells adjacent to each other,
wherein each of the plurality of battery cells includes a rectangular battery case containing an electrode body and an electrolyte solution therein,
the spacer includes a pressing portion configured to press the plurality of battery cells in the first direction by making contact with a predetermined pressing region of an outer surface of the rectangular battery case,
the pressing region, as viewed from the first direction, is configured to overlap a central portion of the electrode body and not to overlap both end portions of the electrode body in a width direction of the battery cell, and
the pressing portion, when viewed from the first direction, has a shape in which a portion overlapping a lower side portion than the central portion of the electrode body is larger than a portion overlapping an upper side portion than the central portion of the electrode body.

2. The battery module according to claim 1, wherein the pressing portion, as viewed from the first direction, has a trapezoidal shape in which a lower bottom is longer than an upper bottom.

3. The battery module according to claim 2, wherein
a length of the upper bottom is 60 to 65% of a width of each of the plurality of battery cells,
a length of the lower bottom is 70 to 80% of the width of each of the plurality of battery cells, and
a height of the trapezoidal shape is 70 to 80% of a height of each of the plurality of battery cells.
